(19) United States
(12) Patent Application Publication
(10) Pub. No.: US 2026/0130441 A1
(43) Pub. Date: May 14, 2026

(54) TESTING ARTICLE FOR USE IN AN AEROSOL-GENERATING DEVICE

(71) Applicant: Philip Morris Products S.A., Neuchatel (CH)

(72) Inventors: Teck Yan CHAN, Singapore (SG); Soon Leong CHEW, Singapore (SG); Marios GEORGIOU, Lausanne (CH); Camille GROSJEAN, Valleiry (FR); Olivier TROISFONTAINE, Cheseaux-sur-Lausanne (CH)

(73) Assignee: Philip Morris Products S.A., Neuchatel (CH)

(21) Appl. No.: 18/706,123

(22) PCT Filed: Nov. 11, 2021
(86) PCT No.: PCT/CN2021/130065

§ 371 Date: Apr. 30, 2024

(51) Int. Cl. A24F 40/80; A24F 40/465; H05B 6/10

(52) U.S. Cl. CPC A24F 40/80; A24F 40/465; H05B 6/105

(57) ABSTRACT

A testing article for insertion into a heating chamber of an aerosol-generating device is provided, the testing article including: an elongate body configured to be received within the heating chamber of the aerosol-generating device; and a heatable substrate configured to be received within the elongate body and to be heated when the testing article is located within the heating chamber of the aerosol-generating device, the heatable substrate being a non-aerosol-generating substrate. A testing system including the testing article is also provided. A method of testing an aerosol-generating device with the testing article is also provided.

The present invention relates to a testing article for insertion into a heating chamber of an aerosol-generating device or heating device. The present disclosure further relates to a testing system comprising the testing article and the aerosol-generating device and a method of testing an aerosol-generating device using the testing article.

Aerosol-generating devices which heat a heatable substrate to produce an aerosol without burning the heatable substrate are known in the art. The heatable substrate is typically provided within a testing article, together with other components such as filters. The testing article may have a rod shape for insertion of the testing article into a heating chamber of the aerosol-generating device. A heating element is typically arranged in or around the heating chamber for heating the heatable substrate once the testing article is inserted into the heating chamber of the aerosol-generating device. During use of the testing article, volatile compounds are released from the heatable substrate by heat transfer from the heat source and are entrained in air drawn through the testing article. As the released compounds cool, they condense to form an aerosol. The heating chamber may be arranged within a housing of the aerosol-generating device and form part of an airflow pathway through the aerosol-generating device. The testing of the heating performance of the aerosol-generating device may require the heating of different articles adapted for use with the device. It is known that an aerosol-generating device may need to endure a relatively high number of sequential heating cycles, particularly where the power source of the device is depleted and recharged in each heating cycle. Using genuine aerosol-generating articles containing aerosol-generating substrates, such as a tobacco material, can be quite expensive and time consuming as carrying out such testing would need regular replacement of the articles throughout the testing. This may be of particular relevance when carrying out lengthy lifecycle performance testing on the power source or heating element of an aerosol-generating device. Lifecycle performance testing of an aerosol-generating device may involve activating and deactivating the aerosol-generating device, and its heating element, for more than 10,000 heating cycles. During each heating cycle, an aerosol-generating article may need to be repeatedly replaced, consumed and removed.

Accordingly, it would be desirable to provide a testing arrangement for an aerosol-generating device or heating device that reduces testing costs and length.

According to the present disclosure, there may be provided a testing article for insertion into a heating chamber configured for receiving aerosol-generating articles. The testing article may comprise an elongate body configured to be received within the heating chamber. The testing article may comprise a heatable substrate configured to be received within the elongate body. The heatable substrate may be configured to be heated when the testing article is located within the heating chamber. The heatable substrate may be a non-aerosol-generating substrate. In other words, the heatable substrate may not be a heatable substrate, which may be configured to generate aerosol that is suitable for consumption or inhalation by a consumer.

The heating chamber may be the heating chamber of an aerosol-generating device. However, a skilled person may appreciate that any heating or testing device having a heating chamber that is configured for heating aerosol-generating articles may be suitable.

According to the present invention, there is provided a testing article for insertion into a heating chamber of an aerosol-generating device. The testing article comprises an elongate body configured to be received within the heating chamber of an aerosol-generating device. The testing article comprises a heatable substrate configured to be received within the elongate body. The heatable substrate is configured to be heated when the testing article is located within the heating chamber of an aerosol-generating device. The heatable substrate is a non-aerosol-generating substrate. In other words, the heatable substrate is not a heatable substrate, which may be configured to generate aerosol that is suitable for consumption or inhalation by a consumer.

According to the present disclosure, there is provided a testing system comprising a testing article in accordance to the present disclosure and a heating device comprising a heating chamber for receiving aerosol-generating articles. The heating device may comprise a heating chamber and a heating element for heating an article received within the heating chamber. Preferably, the heating element is for externally heating an article received within the heating chamber. Preferably, the heating element is an inductive heating element. Preferably, the heating device is an aerosol-generating device.

By providing a testing article adapted for use in an aerosol-generating device that comprises a heatable substrate, which is a non-aerosol-generating substrate, the testing article may be used and heated within an aerosol-generating device a plurality of times. This advantageously renders such an article suitable for testing, thereby removing the need for consistent removal and replacement of the article and reducing testing costs and runtime compared to testing using genuine, heatable testing articles.

The heatable substrate is a non-aerosol-generating substrate. A non-aerosol-generating substrate is considered to be a substrate that is not configured to generate aerosol that is suitable for consumption or inhalation by a consumer. For example, the heatable substrate may not comprise a plant material. The heatable substrate may not comprise a tobacco material. The heatable substrate may not comprise an aerosol former, such as glycerin.

Preferably, the heatable substrate comprises a fibrous material. Preferably, the fibrous material is substantially heat-resistant. The heatable substrate may comprise synthetic fibres. Preferably, the synthetic fibres are substantially heat-resistant. The heatable substrate may comprise carbon fibres, carbon fabric, carbon flock, carbon staple or carbon pulp. The heatable substrate may comprise aramid fibres, aramid fabric, aramid flock, aramid staple or aramid pulp. The heatable substrate may comprise para-aramid fibres, para-aramid fabric, para-aramid flock, para-aramid staple or para-aramid pulp. The heatable substrate may comprise Kevlar fibres, Kevlar fabric, Kevlar flock, Kevlar staple or Kevlar pulp. Kevlar™ may be commercially available from DuPont de Nemours, Inc.

The heatable substrate may comprise a mixture of any of the materials noted above. In particular, the heatable substrate may comprise a mixture of carbon fibres, fabric, staple, flock or pulp and aramid fibres, fabric, staple, flock or pulp. The heatable substrate may comprise a mixture of carbon fibres, flock or pulp and kevlar fibres, flock or pulp. Preferably, the heatable substrate is air permeable, thereby allowing air to flow through the heatable substrate should air be drawn through the testing article. The inventors have found that such materials, such as carbon or aramid, provide a heatable, non-aerosol-generating substrate that may be reusable and durable, while emulating the resistance-to-draw and energy absorption characteristics of a heatable substrate, such as a tobacco-based substrate.

The aerosol-generating device or heating device of the testing system may have a distal end and a mouth end. The aerosol-generating device or heating device may comprise a body. The body or housing of the aerosol-generating or heating device may define a device cavity for removably receiving the testing article at the mouth end of the device. The aerosol-generating or heating device may comprise a heating element or heater for heating the heatable substrate when the testing article is received within the device cavity.

In use, the testing article may be partially inserted into the device cavity or heating chamber of a corresponding aerosol-generating device (or heating device). In order to heat the heatable substrate, the heatable substrate is generally aligned with one or more electrical heater elements of the aerosol-generating device when the testing article is fully inserted into the cavity. It is understood that the term “fully inserted” describes the position of the testing article within a cavity of an aerosol-generating device when it is in the intended position for heating. It does not require that all of the length of the testing article is within the cavity. A portion of the testing article (for example the mouth end) may protrude from the cavity when the testing article is fully inserted in the cavity.

As used herein, the term “length” denotes the dimension of a component of the testing article or heating device (or aerosol-generating device) in the longitudinal direction, from the component's furthest upstream or distal point to the component's furthest downstream or proximal point.

As used herein, the term “longitudinal” refers to the direction corresponding to the main longitudinal axis of the testing article or aerosol-generating device, which extends between the upstream and downstream ends of the testing article or aerosol-generating device. As used herein, the terms “upstream” and “downstream” describe the relative positions of elements, or portions of elements, of the testing article or the aerosol-generating device in relation to the direction in which the air may be drawn through the testing article or aerosol-generating device during use. During testing, air may be drawn through the testing article in the longitudinal direction.

The device cavity may be referred to as the heating chamber of the aerosol-generating device. The device cavity may extend between a distal end and a mouth, or proximal, end. The distal end of the device cavity may be a closed end and the mouth, or proximal, end of the device cavity may be an open end. A testing article may be inserted into the device cavity, or heating chamber, via the open end of the device cavity. The device cavity may be cylindrical in shape so as to conform to the same shape of a testing article.

The expression “received within” may refer to the fact that a component or element is fully or partially received within another component or element. For example, the expression “testing article is received within the device cavity” refers to the testing article being fully or partially received within the device cavity of the testing article. When the testing article is received within the device cavity, the testing article may abut the distal end of the device cavity. When the testing article is received within the device cavity, the testing article may be in substantial proximity to the distal end of the device cavity. The distal end of the device cavity may be defined by an end-wall.

The length of the device cavity may be between about 10 mm and about 50 mm. The length of the device cavity may be between about 20 mm and about 40 mm. The length of the device cavity may be between about 25 mm and about 30 mm.

A diameter of the device cavity may be between about 4 mm and about 10 mm. A diameter of the device cavity may be between about 5 mm and about 9 mm. A diameter of the device cavity may be between about 6 mm and about 8 mm. A diameter of the device cavity may be between about 7 mm and about 8 mm. A diameter of the device cavity may be between about 7 mm and about 7.5 mm.

A diameter of the device cavity may be substantially the same as or greater than a diameter of the testing article. A diameter of the device cavity may be the same as a diameter of the testing article in order to establish a tight fit with the testing article.

The device cavity may be configured to establish a tight fit with a testing article received within the device cavity. Tight fit may refer to a snug fit, press fit or interference fit. The aerosol-generating device may comprise a peripheral wall. Such a peripheral wall may define the device cavity, or heating chamber. The peripheral wall defining the device cavity may be configured to engage with a testing article received within the device cavity in a tight fit manner, so that there is substantially no gap or empty space between the peripheral wall defining the device cavity and the testing article when received within the device.

Such a tight fit may establish an airtight fit or configuration between the device cavity and a testing article received therein.

With such an airtight configuration, there would be substantially no gap or empty space between the peripheral wall defining the device cavity and the testing article for air to flow through. The tight fit with a testing article may be established along the entire length of the device cavity or along a portion of the length of the device cavity.

The aerosol-generating device may comprise an air-flow channel extending between a channel inlet and a channel outlet. The air-flow channel may be configured to establish a fluid communication between the interior of the device cavity and the exterior of the aerosol-generating device. The air-flow channel of the aerosol-generating device may be defined within the housing of the aerosol-generating device to enable fluid communication between the interior of the device cavity and the exterior of the aerosol-generating device. When a testing article is received within the device cavity, the air-flow channel may be configured to provide air flow into the article.

The air-flow channel of the aerosol-generating device may be defined within, or by, the peripheral wall of the housing of the aerosol-generating device. In other words, the air-flow channel of the aerosol-generating device may be defined within the thickness of the peripheral wall or by the inner surface of the peripheral wall, or a combination of both. The air-flow channel may partially be defined by the inner surface of the peripheral wall and may be partially defined within the thickness of the peripheral wall. The inner surface of the peripheral wall defines a peripheral boundary of the device cavity.

The air-flow channel of the aerosol-generating device may extend from an inlet located at the mouth end, or proximal end, of the aerosol-generating device to an outlet located away from mouth end of the device. The air-flow channel may extend along a direction parallel to the longitudinal axis of the aerosol-generating device.

The heater may be any suitable type of heater. Preferably, the heater is an external heater. Preferably, the heater may externally heat the testing article when received within the aerosol-generating device. Such an external heater may circumscribe the testing article when inserted in or received within the aerosol-generating device.

In some embodiments, the heater is arranged to externally heat the heatable substrate. In some embodiments, the heater is arranged for insertion into a heatable substrate when the heatable substrate is received within the cavity. The heater may be positioned within the device cavity, or heating chamber.

The heater may comprise at least one heating element. The at least one heating element may be any suitable type of heating element. In some embodiments, the device comprises only one heating element. In some embodiments, the device comprises a plurality of heating elements. The heater may comprise at least one resistive heating element. Preferably, the heater comprises a plurality of resistive heating elements. Preferably, the resistive heating elements are electrically connected in a parallel arrangement. Advantageously, providing a plurality of resistive heating elements electrically connected in a parallel arrangement may facilitate the delivery of a desired electrical power to the heater while reducing or minimising the voltage required to provide the desired electrical power. Advantageously, reducing or minimising the voltage required to operate the heater may facilitate reducing or minimising the physical size of the power supply.

Suitable materials for forming the at least one resistive heating element include but are not limited to: semiconductors such as doped ceramics, electrically ‘conductive’ ceramics (such as, for example, molybdenum disilicide), carbon, graphite, metals, metal alloys and composite materials made of a ceramic material and a metallic material. Such composite materials may comprise doped or undoped ceramics. Examples of suitable doped ceramics include doped silicon carbides. Examples of suitable metals include titanium, zirconium, tantalum and metals from the platinum group. Examples of suitable metal alloys include stainless steel, nickel-, cobalt-, chromium-, aluminium-, titanium-, zirconium-, hafnium-, niobium-, molybdenum-, tantalum-, tungsten-, tin-, gallium-, manganese- and iron-containing alloys, and super-alloys based on nickel, iron, cobalt, stainless steel, Timetal® and iron-manganese-aluminium based alloys.

In some embodiments, the at least one resistive heating element comprises one or more stamped portions of electrically resistive material, such as stainless steel. Alternatively, the at least one resistive heating element may comprise a heating wire or filament, for example a Ni—Cr (Nickel-Chromium), platinum, tungsten or alloy wire.

In some embodiments, the at least one heating element comprises an electrically insulating substrate, wherein the at least one resistive heating element is provided on the electrically insulating substrate.

The electrically insulating substrate may comprise any suitable material. For example, the electrically insulating substrate may comprise one or more of: paper, glass, ceramic, anodized metal, coated metal, and Polyimide. The ceramic may comprise mica, Alumina (Al2O3) or Zirconia (ZrO2). Preferably, the electrically insulating substrate has a thermal conductivity of less than or equal to about 40 Watts per metre Kelvin, preferably less than or equal to about 20 Watts per metre Kelvin and ideally less than or equal to about 2 Watts per metre Kelvin.

The heater may comprise a heating element comprising a rigid electrically insulating substrate with one or more electrically conductive tracks or wire disposed on its surface. The size and shape of the electrically insulating substrate may allow it to be inserted directly into a heatable substrate. If the electrically insulating substrate is not sufficiently rigid, the heating element may comprise a further reinforcement means. A current may be passed through the one or more electrically conductive tracks to heat the heating element and the heatable substrate.

In some embodiments, the heater comprises an inductive heating arrangement. The inductive heating arrangement may comprise an inductor coil and a power supply configured to provide high frequency oscillating current to the inductor coil. As used herein, a high frequency oscillating current means an oscillating current having a frequency of between about 500 kHz and about 30 MHz. The heater may advantageously comprise a DC/AC inverter for converting a DC current supplied by a DC power supply to the alternating current. The inductor coil may be arranged to generate a high frequency oscillating electromagnetic field on receiving a high frequency oscillating current from the power supply. The inductor coil may be arranged to generate a high frequency oscillating electromagnetic field in the device cavity. In some embodiments, the inductor coil may substantially circumscribe the device cavity. The inductor coil may extend at least partially along the length of the device cavity.

The heater of the aerosol-generating device or heating device may comprise an inductive heating element. The inductive heating element may be a susceptor element. As used herein, the term ‘susceptor element’ refers to an element comprising a material that is capable of converting electromagnetic energy into heat. When a susceptor element is located in an alternating electromagnetic field, the susceptor is heated. Heating of the susceptor element may be the result of at least one of hysteresis losses and eddy currents induced in the susceptor, depending on the electrical and magnetic properties of the susceptor material.

A susceptor element may be arranged such that, when the testing article is received in the cavity of the aerosol-generating device, the oscillating electromagnetic field generated by the inductor coil induces a current in the susceptor element, causing the susceptor element to heat up. In these embodiments, the aerosol-generating device is preferably capable of generating a fluctuating electromagnetic field having a magnetic field strength (H-field strength) of between 1 and 5 kilo amperes per metre (kA m), preferably between 2 and 3 kA/m, for example about 2.5 kA/m. The electrically-operated aerosol-generating device is preferably capable of generating a fluctuating electromagnetic field having a frequency of between 1 and 30 MHz, for example between 1 and 10 MHz, for example between 5 and 7 MHz.

In these embodiments, the susceptor element is preferably located in contact with the heatable substrate. In some embodiments, a susceptor element is located in the aerosol-generating device. In these embodiments, the susceptor element may be located in the device cavity or heating chamber. The aerosol-generating device may comprise only one susceptor element. The aerosol-generating device may comprise a plurality of susceptor elements. In some embodiments, the susceptor element is preferably arranged to heat the outer surface of the heatable substrate.

Most preferably, the testing article comprises a susceptor or susceptor element. The susceptor is preferably located within the heatable substrate. The susceptor may be located in contact with the heatable substrate. The susceptor may be extend along the heatable substrate. The susceptor may extend substantially parallel to the longitudinal axis of the elongate body. The susceptor may be substantially aligned with a central longitudinal axis defined by the elongate body. The susceptor is preferably embedded within the heatable substrate.

The susceptor may be insertable into the heatable substrate. The material of the heatable substrate may surround the susceptor. The material of the heatable substrate may be wrapped around the susceptor. The heatable substrate may define a casing into which the susceptor may be inserted. This advantageously enables the susceptor to be replaced as the susceptor may deteriorate before the surrounding heatable substrate does. The susceptor and the heatable substrate may be define a heatable segment or a heatable substrate segment.

The susceptor element may comprise any suitable material. The susceptor element may be formed from any material that can be inductively heated to a temperature sufficient to release volatile compounds from the heatable substrate. Suitable materials for the elongate susceptor element include graphite, molybdenum, silicon carbide, stainless steels, niobium, aluminium, nickel, nickel containing compounds, titanium, and composites of metallic materials. Some susceptor elements comprise a metal or carbon. Advantageously the susceptor element may comprise or consist of a ferromagnetic material, for example, ferritic iron, a ferromagnetic alloy, such as ferromagnetic steel or stainless steel, ferromagnetic particles, and ferrite. A suitable susceptor element may be, or comprise, aluminium. The susceptor element preferably comprises more than about 5 percent, preferably more than about 20 percent, more preferably more than about 50 percent or more than about 90 percent of ferromagnetic or paramagnetic materials. Some elongate susceptor elements may be heated to a temperature in excess of about 250 degrees Celsius.

The susceptor element may comprise a non-metallic core with a metal layer disposed on the non-metallic core. For example, the susceptor element may comprise metallic tracks formed on an outer surface of a ceramic core or substrate.

Preferably, the elongate body is configured to retain the heatable substrate. The testing article may comprise a substrate cavity for receiving the heatable substrate. The substrate cavity may be defined within the elongate body. The substrate cavity may be extend along the elongate body. A cross section of the substrate cavity may match the shape of the cross section of the heatable substrate or heatable substrate segment. The heatable substrate segment preferably has a substantially rectangular cross section. Thus, a cross section of the substrate cavity may be rectangular to match the shape of the heatable substrate segment.

Preferably, the elongate body is formed from a polymeric material. More preferably, the elongate body is formed from a plastic material. Even more preferably, the elongate body is formed from a thermoplastic material, such as polyether ether ketone (PEEK). It has been found that the plastic materials, such as PEEK, may be suitable for withstanding the high temperatures within the heating chamber. Further, PEEK has a suitable level of heat resistance and mechanical strength for the present testing applications.

The elongate body may extend between a distal end and a proximal end. The distal end may also be referred to as the first end or the upstream end. The proximal end may also be referred to as the second end, the mouth end or the downstream end.

Both ends of the elongate body may be open. In other words, both ends of the elongate body each define an opening. In such embodiments, the elongate body may be hollow. The elongate body may comprise a hollow tube, preferably being cylindrical.

The elongate body may define an air passageway extending downstream from the distal end to the proximal end. The elongate body may define an air passageway extending from the upstream end to the downstream end. Such an air passageway allows air flow testing through the aerosol-generating device and the testing article, and testing of any puff sensors present within the aerosol-generating device.

Alternatively, both ends of the elongate body are substantially closed. In other words, both ends of the elongate body comprise an end face or wall. In such embodiments, a portion of the elongate body may not be hollow. In other words, a portion of the elongate may be solid. Preferably, a proximal or upper portion of the elongate body is solid. This allows the elongate body to absorb heat.

The substrate cavity may be sized or dimensioned such that the heatable substrate is retained within the substrate cavity upon insertion. Preferably, the substrate cavity is defined by an internal cavity surface of the elongate body and the cavity surface is configured to establish an interference or press fit with a portion of the heatable substrate. In other words, the substrate cavity may engage with a portion of the heatable substrate in order to retain the heatable substrate therein. The heatable substrate, particularly when comprising a fibrous or fabric material, may expand within the substrate cavity, thereby furthering the retention of the substrate material within the elongate body.

The testing article may comprise an insertion aperture for providing the heatable substrate with access to the substrate cavity. The insertion aperture may be defined on the elongate body. Prior to insertion of the testing article into the heating chamber of the testing article, the heatable substrate may be inserted into the substrate cavity of the article via the insertion aperture. The insertion aperture may allow easy removal and insertion of the heatable substrate into the testing article. A portion of the insertion aperture may be configured to locate or retain the heatable substrate within the elongate body. A portion of the insertion aperture may be configured to locate the heatable substrate within the elongate body. A portion of the insertion aperture may be configured to retain the heatable substrate within the elongate body. A portion of the insertion aperture may be configured to locate and retain the heatable substrate within the elongate body.

The insertion aperture may extend between two opposing, end portions of the insertion aperture. The opposing end portions of the insertion aperture may be configured to locate or retain the heatable substrate within the elongate body. A portion of the insertion aperture may be configured to establish an interference or press fit or a tight fit with a portion of the heatable substrate. In other words, portions of the heatable substrate may engage with the end portions of the insertion aperture in order for the heatable substrate to be retained within the substrate cavity. The insertion aperture may be an insertion slot. The insertion slot or aperture may beneficially facilitate replacement of the heatable substrate and susceptor, if present, as well as facilitate locating of the substrate cavity during such replacement.

The insertion aperture may be located at a position along the elongate body. In other words, the insertion aperture may extend along the elongate body. The insertion aperture may extend along a direction parallel to a longitudinal axis defined by the elongate body. The insertion aperture may be provided on a lateral or peripheral wall of the elongate body. In such embodiments, the heatable substrate together with a susceptor, if present, may be inserted into the elongate body via a side of the body. The insertion aperture may be provided on the bottom or upstream half of the elongate body.

Alternatively, the insertion aperture may be located at an end of the elongate body. In other words, the insertion aperture may be provided on an end wall of the elongate body. The insertion aperture may extend along a direction perpendicular to a longitudinal axis defined by the elongate body. The insertion aperture may be located at the distal or upstream end of the elongate body. In such embodiments, the heatable substrate together with a susceptor, if present, may be inserted into the elongate body via an end of the body.

The insertion aperture preferably overlies the substrate cavity of the testing article. This facilitates insertion and removal of the substrate, which may include a susceptor, from the testing article. The shape of the insertion aperture is preferably substantially rectangular.

The testing article may further comprise one or more cooling openings for establishing a fluid communication between the heatable substrate and the exterior of the testing article, where the one or more cooling openings are defined on the elongate body. The cooling opening may be located at a position along the elongate body. In other words, the cooling opening may extend along the elongate body. The cooling opening may extend along a direction parallel to a longitudinal axis defined by the elongate body. The testing article may comprise two cooling openings, where the two cooling openings may be longitudinally spaced apart on the elongate body. The cooling opening may be provided on the lower, distal or upstream half of the elongate body. The one or more cooling openings may at least partially overlie the substrate cavity.

The cooling opening may be located at a circumferential position around the periphery of the elongate body. The insertion slot or aperture may be spaced apart from the cooling opening around the periphery of the elongate body. The insertion aperture may be located at an angular or circumferential offset from the one or more cooling openings. The insertion aperture may be located at a circumferential position about 90 degrees offset from the one or more cooling openings.

The one or more cooling openings, particularly in embodiments where the ends of the elongate body are closed, allow heat from the heatable substrate during heating to dissipate, thereby enabling the testing article to closely simulate the air flow and cooling conditions an aerosol-generating article would be under during normal use.

The testing article may further comprise a heat insulating element circumscribing a portion of the elongate body. Where the testing article comprises an insertion aperture or a cooling opening, the heat insulating element may at least partially overlie one or more apertures or openings defined on the elongate body. The heat insulating element may be arranged in a tight manner around the periphery of the elongate body. While the heat insulating element is preferably arranged tightly around the elongate body, the heat insulating element may be configured to slide along the elongate body, preferably with the application of force to overcome any friction. This enables access to the insertion aperture and for the amount of overlap over a cooling opening to be adjusted. The heat insulating element preferably circumscribes the entire periphery of the elongate body.

The or each heat insulating element may be in the form of a sleeve or a sheath. The testing article may comprise a plurality of heat insulating elements arranged at different longitudinal positions along the elongate body. The or each heat insulating element may be wrapped around the elongate body.

The heat insulating element may advantageously prevent heat from being dissipated from the substrate cavity of the testing article during testing. The heat insulating element may comprise a polyimide material, film or tape. The heat insulating element may be an adhesive polyimide film. The heat insulating element may comprise a Kapton film or tape. Kapton ™ may be commercially available from DuPont de Nemours, Inc.

A thickness of a heat insulating element may be between about 0.2 mm and about 0.3 mm. A thickness of a heat insulating element may be between about 0.2 mm and about 0.25 mm. A thickness of a heat insulating element may be between about 0.24 mm and about 0.3 mm.

As discussed above, the elongate body may comprise a hollow tube extending between a distal end and a proximal end. The heatable substrate may be located within the hollow tube. The heatable substrate may be located within a substrate cavity defined within the hollow tube.

The testing article may comprise a filter segment. The filter segment may be positioned within the elongate body. The filter segment may be located downstream of the heatable substrate. The filter segment may be located at the downstream end or mouth end of the testing article. The filter segment may extend from the downstream end or mouth end of the testing article.

The filter segment may comprise at least one mouthpiece filter segment formed of a fibrous filtration material. Suitable fibrous filtration materials would be known to the skilled person. Particularly preferably, the at least one mouthpiece filter segment comprises a cellulose acetate filter segment formed of cellulose acetate tow.

In certain preferred embodiments, the filter segment consists of a single mouthpiece filter segment. In alternative embodiments, the filter segment includes two or more mouthpiece filter segments axially aligned in an abutting end to end relationship with each other.

Preferably, the filter segment has a low particulate filtration efficiency.

The diameter of the mouthpiece element may be between about 5 mm and about 10 mm. The diameter of the mouthpiece element may be between about 6 mm and about 8 mm. The diameter of the mouthpiece element may be between about 7 mm and about 8 mm. The diameter of the filter segment may be about 7.2 mm, plus or minus 10 percent. The diameter of the filter segment may be about 7.25 mm, plus or minus 10 percent

Unless otherwise specified, the resistance to draw (RTD) of a component or the testing article is measured in accordance with ISO 6565-2015. The RTD refers the pressure required to force air through the full length of a component. The terms “pressure drop” or “draw resistance” of a component or article may also refer to the “resistance to draw”. Such terms generally refer to the measurements in accordance with ISO 6565-2015 are normally carried out at under test at a volumetric flow rate of about 17.5 millilitres per second at the output or downstream end of the measured component at a temperature of about 22 degrees Celsius, a pressure of about 101 kPa (about 760 Torr) and a relative humidity of about 60%.

The resistance to draw (RTD) of the filter segment may be at least about 0 mm H₂O. The RTD of the filter segment may be at least about 3 mm H₂O. The RTD of the filter segment may be at least about 6 mm H₂O.

The RTD of the filter segment may be no greater than about 12 mm H₂O. The RTD of the filter segment may be no greater than about 11 mm H₂O. The RTD of the filter segment may be no greater than about 10 mm H₂O.

The resistance to draw of the filter segment may be greater than or equal to about 0 mm H₂O and less than about 12 mm H₂O. Preferably, the resistance to draw of the filter segment may be greater than or equal to about 3 mm H₂O and less than about 12 mm H₂O. The resistance to draw of the filter segment may be greater than or equal to about 0 mm H₂O and less than about 11 mm H₂O. Even more preferably, the resistance to draw of the filter segment may be greater than or equal to about 3 mm H₂O and less than about 11 mm H₂O. Even more preferably, the resistance to draw of the filter segment may be greater than or equal to about 6 mm H₂O and less than about 10 mm H₂O. Preferably, the resistance to draw of the filter segment may be about 8 mm H₂O.

As mentioned above, the filter segment, or mouthpiece filter segment, may be formed of a fibrous material. The filter segment may be formed of a porous material. The filter segment may be formed of a biodegradable material. The filter segment may be formed of a cellulose material, such as cellulose acetate. For example, a filter segment may be formed from a bundle of cellulose acetate fibres having a denier per filament between about 10 and about 15. For example, a filter segment formed from relatively low density cellulose acetate tow, such as cellulose acetate tow comprising fibres of about 12 denier per filament.

The filter segment may be formed of a polylactic acid based material. The filter segment may be formed of a bioplastic material, preferably a starch-based bioplastic material. The filter segment may be made by injection moulding or by extrusion. Bioplastic-based materials are advantageous because they are able to provide filter segment structures which are simple and cheap to manufacture with a particular and complex cross-sectional profile, which may comprise a plurality of relatively large air flow channels extending through the filter segment material, that provides suitable RTD characteristics.

The filter segment may be formed from a sheet of suitable material that has been crimped, pleated, gathered, woven or folded into an element that defines a plurality of longitudinally extending channels. Such sheet of suitable material may be formed of paper, cardboard, a polymer, such as polylactic acid, or any other cellulose-based, paper-based material or bioplastic-based material. A cross-sectional profile of such a filter segment may show the channels as being randomly oriented.

The filter segment may be formed in any other suitable manner. For example, the filter segment may be formed from a bundle of longitudinally extending tubes. The longitudinally extending tubes may be formed from polylactic acid. The filter segment may be formed by extrusion, moulding, lamination, injection, or shredding of a suitable material. Thus, it is preferred that there is a low-pressure drop (or RTD) from an upstream end of the filter segment to a downstream end of the filter segment.

The length of the filter segment may be at least about 3 mm. The length of the filter segment may be at least about 5 mm. The length of the filter segment may be equal to or less than about 11 mm. The length of the filter segment may be equal to or less than about 9 mm. The length of the filter segment may be between about 3 mm and about 11 mm. The length of the filter segment may be between about 5 millimetres and about 9 millimetres. Preferably, the length of the filter segment may be about 7 mm.

The testing article may comprise an upstream segment or front segment. The upstream segment may be positioned within the elongate body. The upstream segment may be located upstream of the heatable substrate. The upstream segment may be located adjacent to the heatable substrate. The upstream segment may be located at the upstream end or distal end of the testing article. The upstream segment may extend from the upstream end or distal end of the testing article.

An upstream element may be a porous plug element. An upstream element may be formed from a material that is impermeable to air.

An upstream element is formed of a hollow tubular segment defining a longitudinal cavity providing an unrestricted flow channel. In such embodiments, an upstream element can provide protection for the heatable substrate, as described above, whilst having a minimal effect on the overall resistance to draw (RTD) and filtration properties of the article.

An upstream element of the upstream section may be made of any material suitable for use in a testing article. The upstream element may, for example, be made of a same material as used for one of the other components of the testing article, such as a filter segment. Suitable materials for forming the upstream element include filter materials, a polymer material, cellulose acetate or cardboard. The upstream element may comprise a plug of cellulose acetate. The upstream element may comprise a hollow acetate tube, or a cardboard tube.

The testing article may comprise a hollow tubular segment. The hollow tubular segment may be positioned within the elongate body. The hollow tubular segment may be located downstream of the heatable substrate. The hollow tubular segment may be located upstream of the heatable substrate. The hollow tubular segment may be located adjacent to the heatable substrate. The hollow tubular segment may be located adjacent to the filter segment. The hollow tubular segment may be located between the heatable substrate and the filter segment. The hollow tubular segment may comprise a cardboard or paper tube.

The hollow tubular segment may have an outer diameter of between 5 millimetres and 12 millimetres, for example of between 5 millimetres and 10 millimetres or of between 6 millimetres and 8 millimetres. In a preferred embodiment, the hollow tubular segment has an external diameter of 7.2 millimetres plus or minus 10 percent.

The hollow tubular segment may have an internal diameter. Preferably, the hollow tubular segment may have a constant internal diameter along a length of the hollow tubular segment. However, the internal diameter of the hollow tubular segment may vary along the length of the hollow tubular segment.

The hollow tubular segment may have an internal diameter of at least about 2 millimetres. For example, the hollow tubular segment may have an internal diameter of at least about 4 millimetres, at least about 5 millimetres, or at least about 7 millimetres.

The hollow tubular segment may have an internal diameter of no more than about 10 millimetres. For example, the hollow tubular segment may have an internal diameter of no more than about 9 millimetres, no more than about 8 millimetres, or no more than about 7.5 millimetres.

The hollow tubular segment may have an internal diameter of between about 2 millimetres and about 10 millimetres, between about 4 millimetres and about 9 millimetres, between about 5 millimetres and about 8 millimetres, or between about 6 millimetres and about 7.5 millimetres.

The hollow tubular segment may have an external diameter of about 7.1 or 7.2 mm. The hollow tubular segment may have an internal diameter of about 6.7 millimetres.

The lumen or cavity of the hollow tubular segment may have any cross sectional shape. The lumen of the hollow tubular segment may have a circular cross sectional shape.

The hollow tubular segment may comprise a paper-based material. The hollow tubular segment may comprise at least one layer of paper. The paper may be very rigid paper. The paper may be crimped paper, such as crimped heat resistant paper or crimped parchment paper.

Preferably, the hollow tubular segment may comprise cardboard. The hollow tubular segment may be a cardboard tube. The hollow tubular segment may be formed from cardboard.

The hollow tubular segment may be paper tube. The hollow tubular segment may be a tube formed from spirally wound paper. The hollow tubular segment may be formed from a plurality of layers of the paper. The paper may have a basis weight of at least about 50 grams per square meter, at least about 60 grams per square meter, at least about 70 grams per square meter, or at least about 90 grams per square meter.

The hollow tubular segment may comprise a polymeric material. For example, the hollow tubular segment may comprise a polymeric film. The polymeric film may comprise a cellulosic film. The hollow tubular segment may comprise low density polyethylene (LDPE) or polyhydroxyalkanoate (PHA) fibres. The hollow tubular segment may comprise cellulose acetate tow.

Where the hollow tubular segment comprises cellulose acetate tow, the cellulose acetate tow may have a denier per filament of between about 2 and about 4 and a total denier of between about 25 and about 40.

Preferably, the substrate cavity of the testing article defined between the hollow tubular segment and the upstream segment. The filter, hollow tubular and upstream segments and the heatable substrate (and susceptor, if present) are preferably inserted into the elongate body. Such segments preferably define an interference or press fit with an internal peripheral surface of the elongate body. Such segments preferably define an airtight fit with an internal peripheral surface of the elongate body.

A length of the testing article may be between about 35 mm and about 50 mm. A length of the testing article may be between about 38 mm and about 47.5 mm. A length of the testing article may be about 40 mm. A length of the testing article may be about 45 mm.

An outer diameter of the testing article may be between about 6 mm and about 8 mm. An outer diameter of the testing article may be between about 6.5 mm and about 8 mm. An outer diameter of the testing article may be between about 6.5 mm and about 7.5 mm. An outer diameter of the testing article may be between about 7 mm. An outer diameter of the testing article may be between about 7.25 mm.

The testing article may comprise a cooling channel for coolant to flow through. The cooling channel may extend through the heatable substrate and the cooling channel may be configured to be in fluid communication with a coolant source. An inlet and an outlet of the cooling channel may be configured to be in fluid communication with a coolant source to form a cooling circuit. The cooling circuit may act like a heat exchanger.

The testing system may further comprise the coolant source, and the pump for pumping coolant from the coolant source through the cooling channel. The coolant source may comprise a thermostatic bath with a pump and coolant located therein. The thermostatic bath may be configured to maintain the temperature of the coolant at a predefined temperature. The pump may be in fluid communication with the inlet and the outlet of the cooling channel so that coolant may be pump from the thermostatic bath through the cooling channel. The provision of such a cooling channel and cooling arrangement may be beneficial to preventing overheating of the heatable substrate and the susceptor, if present, thereby maximising the lifespan of the heatable substrate and reducing testing costs. Further, the provision of such a cooling arrangement may also emulate the heat exchange and dissipation occurring during a puffing action, thereby removing the need to puff on the testing article during testing.

According to the present disclosure, there is provided a method of testing an aerosol-generating device with a testing article according to the present disclosure. The method may comprise the steps of: inserting the testing article into a heating chamber comprising a heating element; performing a testing cycle, wherein the testing cycle comprises: activating the heating element so as to heat the testing article received within the heating chamber; and deactivating the heating element. The heating chamber may be the heating chamber of an aerosol-generating article.

Activation of the heating element may occurring by pressing a button on the heating device or aerosol-generating device or by drawing air through the testing article which may be detected by a puff sensor of the device. A controller in the device may be configured to control the supply of power from a power supply to the heating element in order to heat it up.

Each testing cycle may comprise drawing air through the testing article. The method preferably comprises performing a plurality of the testing cycles. The method preferably comprises performing at least 100 testing cycles, preferably at least 1,000 testing cycles, more preferably at least 2,500 testing cycles, even more preferably at least 5,000 testing cycles.

The testing method may further comprise the step of replacing the heatable substrate of the testing article with a new heatable substrate. Such a step may be performed after the abovementioned plurality of testing cycles have been performed.

In embodiments comprising a testing system having a cooling arrangement as described above, the method of testing may comprise the steps of: inserting the testing article into a heating chamber comprising a heating element; and performing a testing cycle, wherein the testing cycle comprises: activating the heating element so as to heat the testing article received within the heating chamber; operating the pump so that coolant from the coolant source flows through the cooling channel; and deactivating the heating element. The heating chamber may be the heating chamber of an aerosol-generating article.

The testing article may comprise a pressure sensor in order to provide pressure data during the testing. The testing article may comprise a temperature sensor in order to provide temperature data during the testing. The testing method may further comprise a step of obtaining measurement data during a testing cycle. The testing method may further comprise a step of recording measurement data during a testing cycle. The measurement data may comprise one or more of pressure data, resistance-to-draw data, air flow data, and temperature data within the testing article or in the heating chamber of the aerosol-generating device. The measurement data may comprise power information concerning the power supplied by the power source of the device to the heating element.

The invention is defined in the claims. However, below there is provided a non-exhaustive list of non-limiting examples. Any one or more of the features of these examples may be combined with any one or more features of another example, embodiment, or aspect described herein.
EX1. A testing article for insertion into a heating chamber configured for receiving aerosol-generating articles, the testing article comprising:
   an elongate body configured to be received within the heating chamber; and
   a heatable substrate configured to be received within the elongate body, wherein the heatable substrate is configured to be heated when the testing article is located within the heating chamber, wherein the heatable substrate is a non-aerosol-generating substrate.
EX1A. A testing article for insertion into a heating chamber of an aerosol-generating device, the testing article comprising:
   an elongate body configured to be received within the heating chamber of an aerosol-generating device; and
   a heatable substrate configured to be received within the elongate body, wherein the heatable substrate is configured to be heated when the testing article is located within the heating chamber of an aerosol-generating device, wherein the heatable substrate is a non-aerosol-generating substrate.
EX2. A testing article according to any preceding example, wherein the heatable substrate does not comprise a tobacco material.
EX3. A testing article according to any preceding example, wherein the heatable substrate comprises a fibrous material.
EX4. A testing article according to any one of examples EX1-EX3, wherein the heatable substrate comprises carbon fibres, flock or pulp.
EX5. A testing article according to any one of examples EX1-EX3, wherein the heatable substrate comprises aramid fibres, flock or pulp.
EX6. A testing article according to any one of examples EX1-EX3, wherein the heatable substrate comprises Kevlar fibres, flock or pulp.
EX7. A testing article according to any one of examples EX1-EX3, wherein the heatable substrate comprises a mixture of carbon fibres, flock or pulp and aramid fibres, flock or pulp.
EX8. A testing article according to any preceding example, wherein the elongate body is configured to retain the heatable substrate.
EX9. A testing article according to any preceding example, further comprising a substrate cavity for receiving the heatable substrate, the substrate cavity being defined within the elongate body.
EX10. A testing article according to any preceding example, wherein the elongate body is formed from a polymeric material.
EX11. A testing article according to any preceding example, wherein the elongate body is formed from a plastic material.
EX12. A testing article according to any preceding example, wherein the elongate body is formed from a thermoplastic material, preferably polyether ether ketone (PEEK).
EX13. A testing article according to any one of examples EX1-EX12, wherein the elongate body extends between a distal end and a proximal end, wherein both ends of the elongate body are open.
EX14. A testing article according to any one of examples EX1-EX13, wherein the elongate body defines an air passageway extending downstream from the distal end to the proximal end.
EX15. A testing article according to any one of examples EX1-EX12, wherein the elongate body extends between a distal end and a proximal end, wherein both ends of the elongate body are closed.
EX16. A testing article according to example EX9, wherein the substrate cavity is dimensioned such that the heatable substrate is retained within the substrate cavity upon insertion.
EX17. A testing article according to example EX9, wherein the substrate cavity is defined by an internal cavity surface of the elongate body, the cavity surface being configured to establish an interference fit with a portion of the heatable substrate.
EX18. A testing article according any preceding example, further comprising an insertion aperture for providing the heatable substrate with access to the substrate cavity, the insertion aperture being defined on the elongate body.
EX19. A testing article according to example EX18, wherein a portion of the insertion aperture is configured to locate or retain the heatable substrate within the elongate body.
EX20. A testing article according to example EX18, wherein opposing end portions of the insertion aperture are configured to locate or retain the heatable substrate within the elongate body.
EX21. A testing article according to example EX18, wherein a portion of the insertion aperture is configured to establish an interference fit with a portion of the heatable substrate.
EX22. A testing article according to any one of examples EX18-EX21, wherein the insertion aperture is an insertion slot.
EX23. A testing article according to any one of examples EX18-EX22, wherein the insertion aperture is located at a position along the elongate body.
EX24. A testing article according to example EX23, wherein the insertion aperture extends along a direction parallel to a longitudinal axis defined by the elongate body.
EX25. A testing article according to example EX23 or EX24, wherein the insertion aperture is provided on a lateral or peripheral wall of the elongate body.
EX26. A testing article according to any one of examples EX18-EX22, wherein the insertion aperture is located at a distal end of the elongate body.
EX27. A testing article according to example EX26, wherein the insertion aperture extends along a direction perpendicular to a longitudinal axis defined by the elongate body.
EX28. A testing article according to example EX26 or EX27, wherein the insertion aperture is provided on a distal end wall of the elongate body.
EX29. A testing article according to any preceding example, further comprising a cooling opening for establishing a fluid communication between the heatable substrate and the exterior of the testing article, the cooling opening being defined on the elongate body.
EX30. A testing article according to any preceding example, further comprising a heat insulating element circumscribing a portion of the elongate body.
EX31. A testing article according to any preceding example, wherein the heat insulating element overlies one or more apertures or openings defined on the elongate body.
EX32. A testing article according to any one of examples EX1-EX14, wherein the elongate body comprises a hollow tube extending between a distal end and a proximal end, the heatable substrate being located within the hollow tube.
EX33. A testing article according to example EX32, further comprising a filter segment, the filter segment being positioned within the elongate body and downstream of the heatable substrate.
EX34. A testing article according to example EX32 or EX33, further comprising a hollow tubular segment, the hollow tubular segment being positioned within the elongate body and downstream of the heatable substrate.
EX35. A testing article according to any one of examples EX32-EX34, further comprising an upstream segment, the upstream segment being positioned within the elongate body and upstream of the heatable substrate.
EX36. A testing article according to example EX32, further comprising an upstream segment located adjacent to the heatable substrate, a hollow tubular segment located adjacent to the heatable substrate and a filter segment located adjacent to the hollow tubular segment, wherein the upstream segment, the hollow tubular segment and the filter segment are located within the hollow tube.
EX37. A testing article according to example EX34 or EX36, wherein the hollow tubular segment comprises a cardboard or paper tube.
EX38. A testing article according to any preceding example, further comprising a susceptor, the substrate being located within the heatable substrate.
EX39. A testing article according to example EX38, wherein the susceptor extends along the heatable substrate.
EX40. A testing article according to example EX38, wherein the susceptor extends substantially parallel to the longitudinal axis of the elongate body.
EX41. A testing article according to example EX38, wherein the susceptor is substantially aligned with a central longitudinal axis defined by the elongate body.
EX42. A testing article according to any preceding example, further comprising a cooling channel for coolant to flow through, wherein the cooling channel extends through the heatable substrate and wherein the cooling channel is configured to be in fluid communication with a coolant source.
EX43. A testing article according to example EX42, wherein an inlet and an outlet of the cooling channel are configured to be in fluid communication with a coolant source to form a cooling circuit.
EX44. A testing article according to any preceding example, wherein a length of the testing article is between 35 mm and 45 mm.
EX45. A testing article according to any preceding example, wherein an outer diameter of the testing article is between 6 mm and 8 mm.
EX46. A testing article according to example EX30 or EX31, wherein a thickness of the heat insulating element is between 0.2 mm and 0.3 mm.
EX47. A testing system comprising a testing article according to any preceding example and an aerosol-generating device, the aerosol-generating device comprising a heating chamber and a heating element for externally heating an article received within the heating chamber.
EX48. A testing system according to example EX47, wherein the heating element is an inductive heating element.
EX49. A testing system comprising a testing article according to example EX42 or EX43 or EX47, a coolant source, and a pump for pumping coolant from the coolant source through the cooling channel.
EX50. A method of testing an aerosol-generating device with a testing article according to any one preceding examples, comprising the steps of:
   inserting the testing article into a heating chamber of the aerosol-generating device comprising a heating element; and
   performing a testing cycle, wherein the testing cycle comprises:
      activating the heating element so as to heat the testing article received within the heating chamber; and
      deactivating the heating element.
EX51. A method of testing an aerosol-generating device according to example EX50, wherein each testing cycle comprises drawing air through the testing article.
EX52. A method of testing an aerosol-generating device according to example EX50 or EX51, wherein a plurality of testing cycles is performed.
EX53. A method of testing an aerosol-generating device according to any one of examples EX50-EX52, further comprising the step of replacing the heatable substrate of the testing article.
EX54. A method of testing an aerosol-generating device with a testing article of a testing system according to example EX49, comprising the steps of:
   inserting the testing article into a heating chamber of the aerosol-generating device comprising a heating element; and
   performing a testing cycle, wherein the testing cycle comprises:
      activating the heating element so as to heat the testing article received within the heating chamber;
      operating the pump so that coolant from the coolant source flows through the cooling channel; and
      deactivating the heating element.

In the following, the invention will be further described with reference to the drawings of the accompanying Figures, wherein:

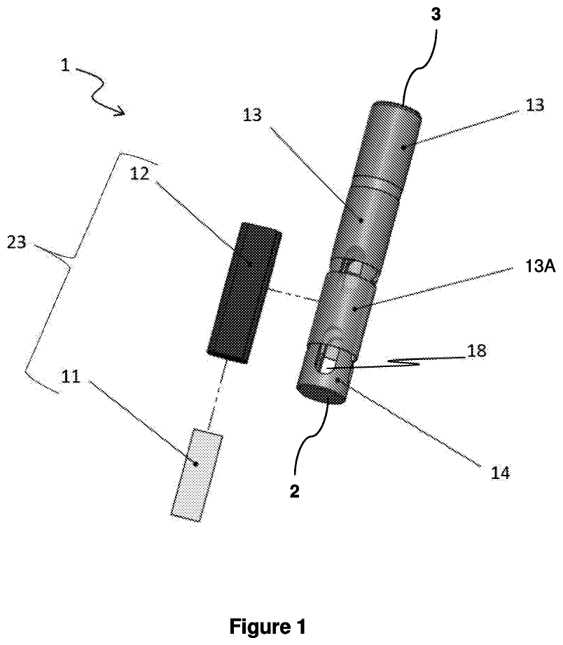

FIG. 1 shows an exploded perspective view of a testing article in accordance with an embodiment of the present invention;

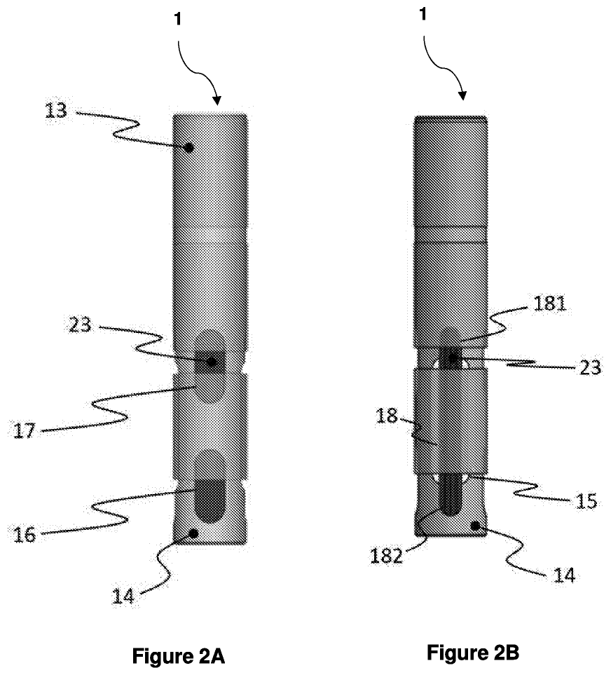

FIGS. 2A & 2B each show a schematic side view of a testing article shown in FIG. 1;

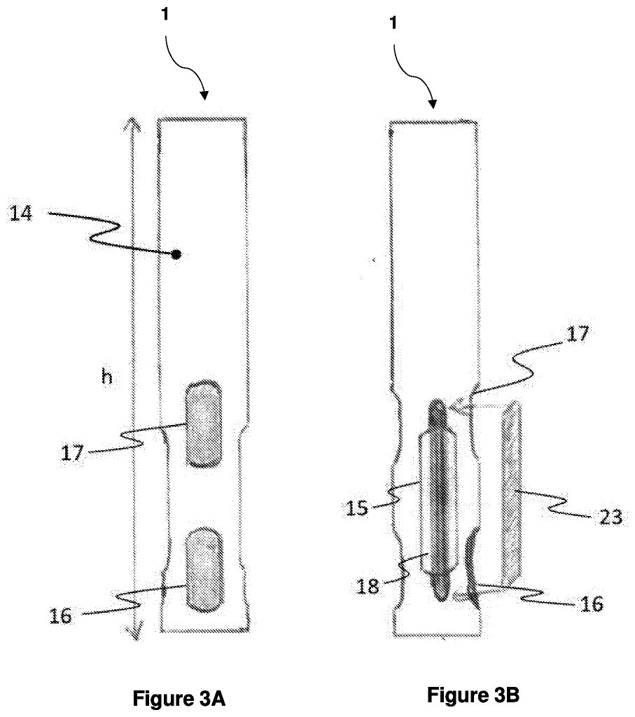

FIGS. 3A & 3B each further show a schematic side view of the embodiment of a testing article shown in FIG. 1;

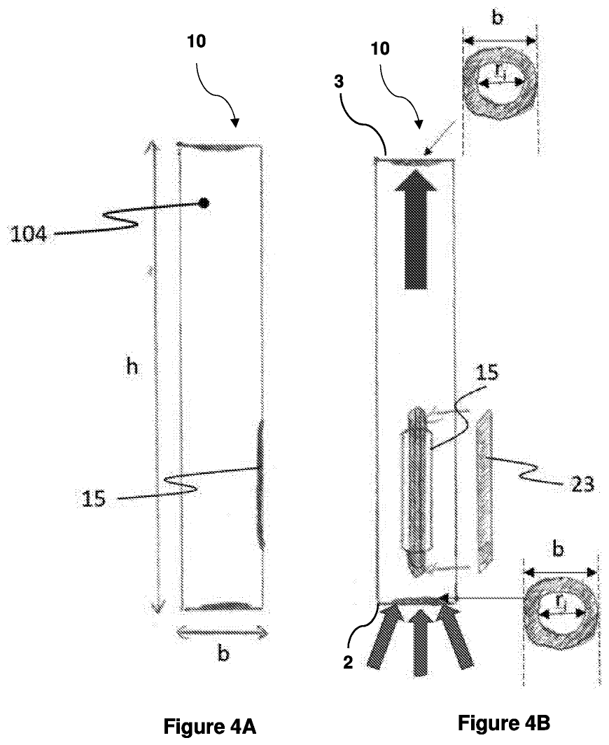

FIGS. 4A & 4B each show a schematic side view of another embodiment of a testing article in accordance with the present invention;

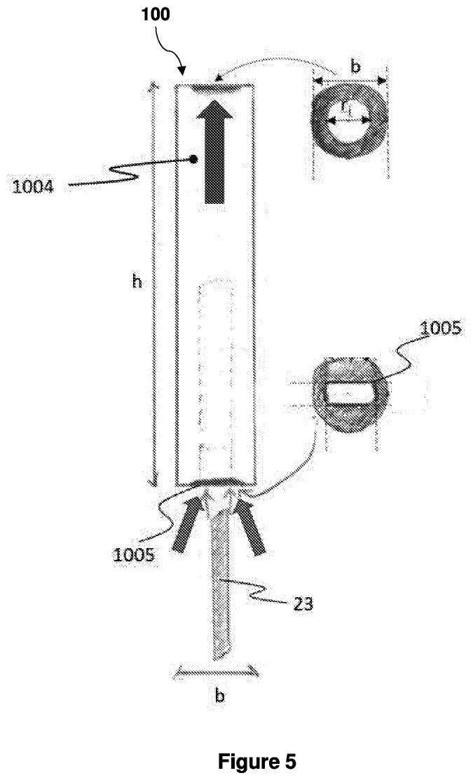

FIG. 5 shows a schematic side view of another embodiment of a testing article in accordance with the present invention;

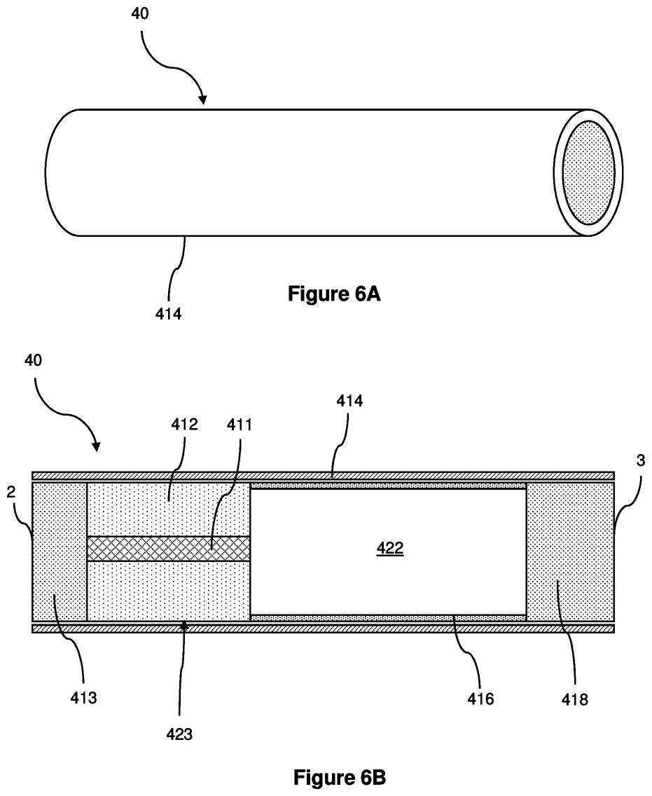

FIGS. 6A & 6B each show a schematic side view of another embodiment of a testing article in accordance with the present invention;

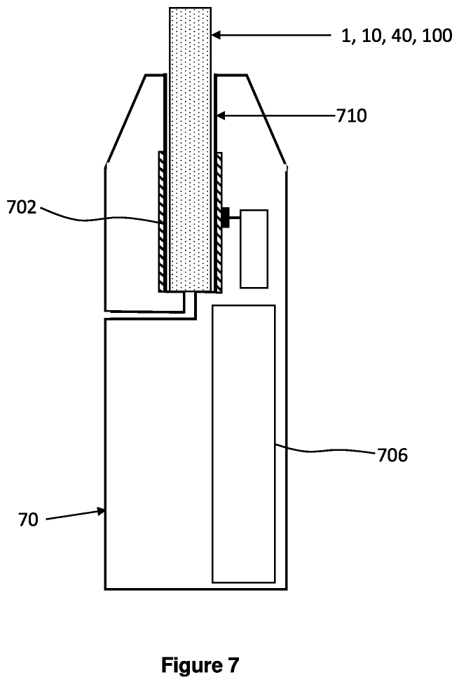

FIG. 7 shows a schematic side sectional view of a testing system in accordance with the invention; and

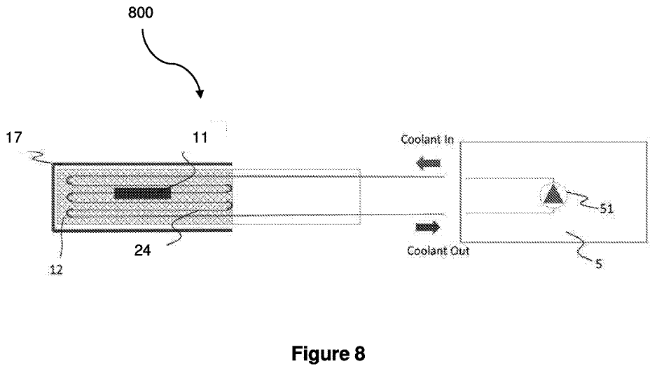

FIG. 8 shows a schematic side sectional view of another testing system in accordance with the invention.

FIG. 1 shows a testing article 1 for use in an aerosol-generating device. The testing article 1 is configured to be inserted into the heating chamber of an aerosol-generating device and is configured to be heated therein.

The testing article 1 comprises a cylindrical elongate body 14 extending between a distal end 2 and a proximal end 3. The testing article 1 comprises a heatable substrate 12 that is configured to be received by the elongate body 14. The testing article 1 further comprises a susceptor 11 arranged to be received within the heatable substrate 12, as shown in FIG. 1. The heatable substrate 12 and the susceptor 11 define a heatable substrate segment 23. The heatable substrate 12 comprises a mixture of carbon fibre and aramid fibres, and does not comprise a plant-based material, such as tobacco. The elongate body 14 is formed from PEEK.

The testing article 1 comprises a substrate cavity 18 defined within the elongate body 14. The heatable substrate segment 23 is configured to be fully received within (or inserted into) the substrate cavity 18 via an insertion slot 15, as shown in FIG. 2B. The insertion slot 15 is positioned along the elongate body 14. In other words, the insertion slot 15 is located on the side of the elongate body 14. Therefore, the heatable substrate segment 23 is inserted through the side of the elongate body 14.

As shown in FIG. 2B, opposing portions 181, 182 of an internal surface defining the substrate cavity 18 are configured to engage with and retain the substrate segment 23 in the cavity 18, upon insertion of the substrate segment 23. The insertion slot 15 also provides a means for guiding the substrate segment 23 into the cavity 18.

As shown in FIGS. 1 and 2A, the testing article 1 comprises at least two cooling openings 16, 17 overlying the substrate cavity 18. As shown in FIG. 2A, the cooling openings 16,17 are located along the lower (or upstream) portion of the elongate body 14 and are longitudinally spaced from each other. The cooling openings 16, 17 are configured to provide fluid communication between the cavity 18 and the exterior of the testing article 1, so that heat from the heatable substrate segment 23 may dissipate when the testing article 1 is being heated within an aerosol-generating device or a heating device during testing.

Further, the testing article 1 comprises three heat insulating sleeves 13 circumscribing the elongate body 14. The three insulating sleeves 13 are longitudinally spaced along the elongate body 14. One of the insulating sleeves 13A partially overlies both cooling openings 16, 17, as shown in FIG. 2A. As shown in FIG. 3B, the same insulating sleeve 13A partially overlies the insertion slot 18. The heat insulating sleeves 13 are each formed from a polyimide material.

In the embodiment of FIGS. 1, 2A and 2B, both ends 2, 3 of the elongate body 14 are closed. FIG. 3B schematically illustrates the insertion of the heatable substrate segment 23 into the elongate body 14 via the insertion slot 15. The length h of the elongate body 14 is about 40 mm and the outer diameter b of the elongate body 14 is 7 mm.

The embodiment shown in FIGS. 4A and 4B is similar to the first embodiment of FIGS. 1, 2A, 2B, 3A and 3B and differs in that the elongate body 104 is a hollow tube having open distal and proximal ends. Therefore, the testing article 10 comprises a hollow elongate body 104 that defines an air passageway extending between the open distal end 2 and the open proximal end 3. Air may therefore flow through the testing article 10 during puff testing. In the embodiment of FIGS. 4A & 4B, the length h of the elongate body 14 is about 40 mm and the outer diameter b of the elongate body 14 is 7 mm. Given that the elongate body is hollow, an internal diameter rᵢ is defined. As an example, such an internal diameter may be about 5 mm. A heat insulating sleeve (not shown) may be provided around the insertion slot 15.

The embodiment shown in FIG. 5 is similar to the second embodiment of FIGS. 4A and 4B, but differs in that the insertion aperture 1005 of testing article 100 is located at the distal end 3 of the elongate body 1004 instead of along the side of the elongate body, and heat insulating sleeves and cooling openings are not provided. The elongate body 1004 is also hollow. An upstream or lower portion of the elongate body 1004 defines the substrate cavity 18. The substrate cavity 18 is defined by an internal surface of the hollow elongate body 1004. Such an internal surface is sized such that it is configured to receive and retain the heatable substrate segment 23 within the substrate cavity 18. As shown in FIG. 5, the cross-section of the cavity 18 is substantially rectangular so as to correspond with the substantially rectangular cross-section of the heatable substrate segment 23. Air may flow through the distal end 3 of the elongate body 1004, through the heatable substrate segment 23 and exit the proximal end 2 of the elongate body 1004. The length h and outer diameter b may be equivalent to the embodiment of FIGS. 4A & 4B.

The embodiment shown in FIGS. 6A & 6B intends to more closely emulate a heatable aerosol-generating article in terms of components. The testing article 40 comprises an elongate body 414 that is in the form of a hollow tube. The elongate body 414 is made from PEEK. The elongate body 414 hosts in linear sequential order and in abutment an upstream segment 413, a heatable substrate segment 423, a hollow tubular segment 416 defining an empty cavity 422, and a filter segment 418. The upstream segment 413 and the hollow tubular segment 422 define the substrate cavity, which receives the heatable substrate segment 423.

The heatable substrate segment 423 comprises a heatable substrate 413 and an elongate susceptor element 411 located centrally within the heatable substrate 413. In other words, the susceptor element 411 is embedded within the heatable substrate 413. The heatable substrate 413 comprise aramid fibres. The hollow tubular segment 416 is made from cardboard. The filter segment 418 is a plug of cellulose acetate. The upstream segment 413 is also a plug of cellulose acetate material, but may also comprise a hollow tubular segment. Air may flow axially through the testing article 40. In the embodiment of FIGS. 6A & 6B, a length of the elongate body 14 is about 45 mm and an outer diameter of the elongate body 14 is about 7.25 mm.

FIG. 7 shows a testing system 700 comprising a testing article 1, 10, 40, 100 in accordance with any embodiment described within the present disclosure and an aerosol-generating device or heating device 70 comprising a power source 706. As shown in FIG. 7, the testing article 1 is received within a heating chamber 710 of the aerosol-generating device 70. The aerosol-generating device 70 comprises a heating element or heater 702 circumscribing a portion of the heating chamber 710. The heating element 702 is an inductive heating element and is arranged to externally and inductively heat the heatable substrate segment of the testing article 1. The heating element 702 is arranged to be activated or powered by the power source 706 via a controller (not shown). A puff sensor (not shown) may also be provided in the heating device 70. Air may be drawn through an air flow channel of the device 70 and through or around the testing article 1.

FIG. 8 shows a schematic diagram of a testing system 800 comprising a testing article, in accordance with one of the embodiments described within the present disclosure, inserted within a heating chamber 17 of a testing device or an aerosol-generating device. The testing article 1 comprises a cooling channel 24 for coolant to flow through. The cooling channel 24 extends through the heatable substrate 12 and the cooling channel 24 is configured to be in fluid communication with a coolant source 5. The coolant source 5 comprises a pump 51 located therein. An inlet and an outlet of the cooling channel 24 are configured to be in fluid communication with a coolant source 5 to form a cooling circuit. More precisely, an inlet and an outlet of the cooling channel 24 are in fluid communication with the pump 51 to form the cooling circuit. The pump 51 is arranged to pump coolant from the coolant source 5 through the cooling channel 24. A portion of the cooling channel 24 is arranged in proximity to the susceptor element 11 in order to extract heat from it. The cooling channel 24 extending through the heatable substrate 12 also extracts heat from the heatable substrate 12. Such a testing system 800 is not arranged to be puffed and the cooling circuit is configured to emulate the level of cooling provided by air flowing through an aerosol-generating article.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±10 % of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-54. (canceled)

55. A testing article for insertion into a heating chamber of an aerosol-generating device, the testing article comprising:
an elongate body configured to be received within the heating chamber of the aerosol-generating device; and
a heatable substrate configured to be received within the elongate body and to be heated when the testing article is located within the heating chamber of the aerosol-generating device, wherein the heatable substrate is a non-aerosol-generating substrate.

56. The testing article according to claim 55, wherein the heatable substrate does not comprise a tobacco material.

57. The testing article according to claim 55, wherein the heatable substrate comprises a fibrous material.

58. The testing article according to claim 55, wherein the heatable substrate comprises carbon fibres, flock, or pulp.

59. The testing article according to claim 55, further comprising a substrate cavity configured to receive the heatable substrate, the substrate cavity being defined within the elongate body.

60. The testing article according to claim 55, wherein the elongate body is formed from a thermoplastic material.

61. The testing article according to claim 55, wherein the elongate body is formed from polyether ether ketone (PEEK).

62. The testing article according to claim 55, further comprising a cooling opening configured to establish a fluid communication between the heatable substrate and an exterior of the testing article, the cooling opening being defined on the elongate body.

63. The testing article according to claim 55, further comprising a heat insulating element circumscribing a portion of the elongate body.

64. The testing article according to claim 55, further comprising a susceptor disposed within the heatable substrate.

65. The testing article according to claim 64, wherein the susceptor extends along the heatable substrate.

66. A testing system comprising a testing article according to claim 55 and an aerosol-generating device, the aerosol-generating device comprising a heating chamber and a heating element configured to externally heat a testing article received within the heating chamber.

67. A method of testing an aerosol-generating device with a testing article according to claim 55, the method comprising the steps of:
inserting the testing article into a heating chamber of the aerosol-generating device comprising a heating element; and
performing a testing cycle comprising:
activating the heating element so as to heat the testing article received within the heating chamber, and
deactivating the heating element.

68. The method of testing an aerosol-generating device according to claim 67, wherein each testing cycle comprises drawing air through the testing article.

69. The method of testing an aerosol-generating device according to claim 67, wherein a plurality of testing cycles is performed.

70. A method of testing an aerosol-generating device with a testing article according to claim 55, the testing article further comprising a cooling channel configured for coolant to flow through, wherein the cooling channel extends through the heatable substrate, wherein the cooling channel is further configured to be in fluid communication with a coolant source, wherein an inlet and an outlet of the cooling channel are configured to be in fluid communication with a coolant source to form a cooling circuit, the method comprising the steps of:
inserting the testing article into a heating chamber of the aerosol-generating device comprising a heating element; and
performing a testing cycle comprising:
activating the heating element so as to heat the testing article received within the heating chamber,
operating a pump so that coolant from a coolant source flows through the cooling channel, and
deactivating the heating element.
